(19) United States
(12) Patent Application Publication
(10) Pub. No.: US 2006/0014033 A1
(43) Pub. Date: Jan. 19, 2006

(54) Preparing of leather for sticking on stones

(76) Inventors: Thomas Brunner, Ried im Zillertal (AT); Bernhard Hofer, Telfes im Stubai (AT)

Correspondence Address: WENDEROTH, LIND & PONACK, L.L.P., 2033 K STREET N. W., SUITE 800, WASHINGTON, DC, 20006-1021, US

(21) Appl. No.: 11/153,422

(22) Filed: Jun. 16, 2005

(30) Foreign Application Priority Data
Jun. 28, 2004 (AT) GM 446/2004

(51) Int. Cl. B32B 9/02

(52) U.S. Cl. 428/473

(57) ABSTRACT

A method of preparing leather for sticking on stones, in particular faceted glass having a flat rear side, wherein a plurality of elongate bores which lead into the interior of the leather are provided in the region of the leather which is intended for glueing on a stone.

The invention relates to a method of preparing leather for sticking on stones, in particular faceted glass having a flat rear side.

Leather is a natural product in which it is possible to distinguish a plurality of layers of fibres which are joined together. From the outside, the porous grain is followed by the papillary layer with fibres which extend normal to the surface, and that is then followed by the verticular layer which is oriented parallel to the surface and which is divided in the production of split leather. In the processed condition, disposed on the outside of the leather is the so-called dressing, a water-tight layer, which is produced by the leather being ground, embossed and treated with various chemical substances.

It is known that the dressed grain side of the leather must be prepared for a glueing operation as a material which is stuck on to the dressing would become detached together therewith. If two pieces of leather are to be glued together therefore the dressing is firstly ground away.

It has already been proposed (see US No 2002/0117258 A1) for glass stones to be joined to leather by a procedure whereby the stones whose rear side is provided with a hot melt adhesive are pressed through the dressing, using ultrasound. In that situation that layer is destroyed and the stones which are held predominantly at the lateral edge by the leather drop off from time to time, as soon as the leather is drawn over bars or rails.

The invention avoids that disadvantage in that a plurality of elongate bores which lead into the interior of the leather are provided in the region of the leather which is intended for glueing on a stone.

This measure takes account of the fact that a stone which is only glued to the dressing can be torn off together therewith, but on the other hand it provides that, in the region beneath the stone, the dressing layer is maintained as a cohesive grid.

Desirably the bores provided are disposed only in those partial regions of the leather, which are later to be covered by stones. Five to ten bores which are produced by a punch provided with needles in the same operation have proven their worth for a stone of the usual size, for example of a diameter of 7 mm.

If a number of stones are to be applied in accordance with a predetermined pattern, the information about that pattern can be passed to a control device which guides a plotter with the needle punch secured thereto to those locations which are subsequently to be covered by stones. The feed of the stones can then be effected individually, but even better by means of a transfer film which already correctly associates the stones coated with hot melt adhesive, with the pretreated fixing locations. Activation of the hot melt adhesive can be effected in the usual way by applying heat and pressure (also using ultrasound).

Further details of the invention are described hereinafter with reference to the drawing in which:

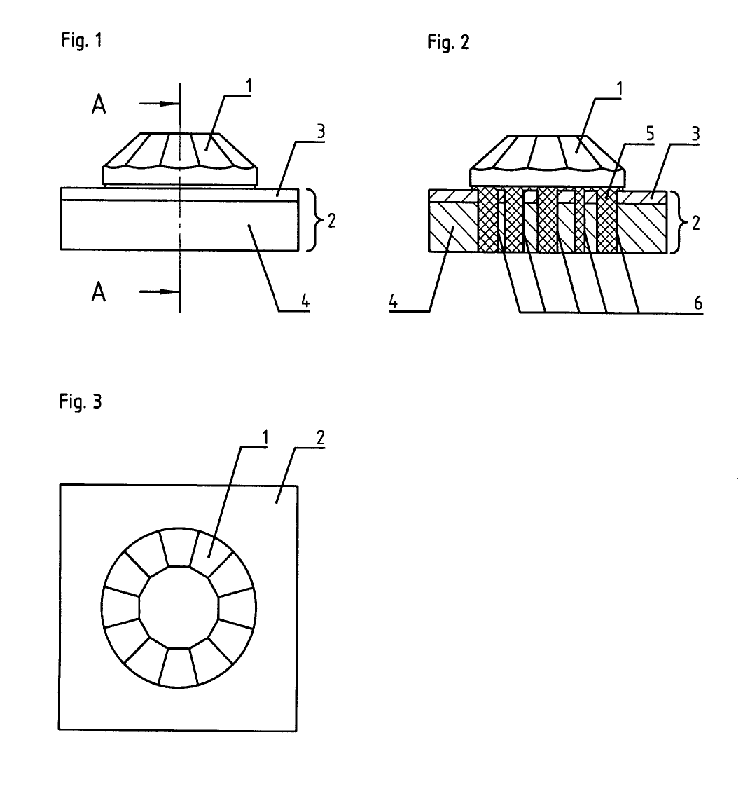

FIG. 1 is a side view of leather prepared according to the invention, with a stone glued thereto,

FIG. 2 shows a vertical section on line A-A, and

FIG. 3 shows the associated plan view.

As stated the invention involves a method of applying stones 1 to a leather 2. The stones 1 can comprise in particular faceted glass and have a flat rear side. Those so-called roses are at the present time applied in a large number individually or in the form of patterns, in particular to textile substrates. The stone and the substrate are joined by way of a hot melt adhesive which is activated by ironing.

The application of such stones to leather is made difficult by virtue of the fact that the base layer 4 of the leather is not sufficiently strongly joined to the dressing 3 which delimits the leather in an outward direction. When relatively severe loadings are applied it is possible for the stone 1 together with the dressing 3 to be torn away from the base layer 4.

Reference is now made to FIG. 2 showing how it is possible to prevent the dressing 3 from being torn away from the base layer 4: firstly bores 6 are produced in that region of the leather 2, which is to be covered by a stone 1. As shown in FIG. 2, the bores 6 can penetrate through the entire thickness of the leather. In general terms however, to provide a secure anchorage, it is sufficient for at least the outermost layer of the leather, the so-called grain layer, to be penetrated and for the bores 6 to terminate beneath same.

All bores 6 associated with a stone 1 can be simultaneously pressed into the leather with a single punch equipped with needles. If that punch is fixed to a plotter, then the punch can be guided to any locations above the surface of the leather. That is desirable in particular when a plurality of stones are already available in the form of a pattern, arranged on a transfer film, and can thus be applied in a single operation to the perforated regions of the leather.

When the hot melt adhesive 5 arranged at the rear side of the stones 1 is activated, then, as diagrammatically shown in FIG. 2, it flows into the bores 6 and thereby anchors the stone 1 in the base layer 4 of the leather. At the same time the stone 1 rests on the parts of the dressing 3, which have remained between the bores 6 and which are cohesively interconnected in a network-like configuration.

1. A method of preparing leather for sticking on stones characterised in that a plurality of elongate bores which lead into the interior of the leather are provided in the region of the leather which is intended for glueing on a stone.

2. A method according to claim 1 wherein the surface of the leather which is covered by a stone is provided with at least five bores.

3. A method according to claim 2 wherein there are provided at most ten bores.

4. A method according to claim 1 wherein the bores are produced by needles.

5. A method according to claim 4 wherein the bores are produced by a punch equipped with a plurality of needles.

6. A method according to claim 1 wherein bores are produced only in the part of the surface of the leather, to which stones are to be glued.

7. A method according to claim 6 wherein the regions provided with bores are distributed in a pattern form over the leather.

8. A method according to claim 7 wherein the pattern is produced by a punch guided by a plotter.

9. Method of claim 1, wherein at least one stone is a faceted glass having a flat rear side.

10. Leather with stones glued thereon, with bores produced in accordance with claim 1, characterised in that an adhesive, in particular a hot melt adhesive, extends from the rear side of the stones into the bores.

11. An article produced using the leather according to claim 10.

12. An article according to claim 11 which is in the form of a bag or a shoe.
